(19) United States
(12) Patent Application Publication
(10) Pub. No.: US 2011/0296928 A1
(43) Pub. Date: Dec. 8, 2011

(54) PRESSURE DETECTION DEVICE FOR USE IN ELECTRONIC MANOMETER

(75) Inventor: Chen-Heng CHENG, Taichung County (TW)

(73) Assignee: BIOTEST MEDICAL CORPORATION, Tanzih Township (TW)

(21) Appl. No.: 12/982,388

(22) Filed: Dec. 30, 2010

(30) Foreign Application Priority Data
Jun. 3, 2010 (TW) 99117969

(51) Int. Cl. G01L 7/18

(52) U.S. Cl. 73/749

(57) ABSTRACT

A pressure detection device for use in an electronic manometer includes a container for receiving a liquid, a first conduit for the air to pass through, and a second conduit for the liquid to flow therein. When the air having the same pressure as that of a pressure transducer is directly or indirectly drawn from the electronic manometer through the first conduit into the container, the liquid in the container flows into the second conduit due to the pressure difference. In this way, get a difference between the liquid level of the second conduit and that of the container and compare the difference with a user's blood pressure measured by the electronic manometer to detect whether the measuring result of the electronic manometer is accurate or not.

### BACKGROUND OF THE INVENTION

1. Field of the Invention

The present invention relates generally to an electronic manometer, and more particularly, to a pressure detection device for use in an electronic manometer.

2. Description of the Related Art

The commercially available manometers can be divided into the mercurial type and the electronic type. As for the mercurial manometer, its accuracy is though high, but the ordinary people need training for correct operation of the same. Besides, no use of any object containing mercury is the dominant trend for environment protection in the current world. Therefore, the electronic manometer is more suitable for one hypertensive patient to use at home, thus facilitating monitoring and getting hold of the patient's condition at any time.

However, the conventional electronic manometer is subject to measuring errors resulting from environmental factors. For the hypertensive patient, the electronic manometer with inaccuracy not only fails to monitor the blood pressure but may also delay the patient's condition.

### SUMMARY OF THE INVENTION

The primary objective of the present invention is to provide a pressure detection device, which can be used in an electronic manometer for detecting whether the measurement of the manometer is accurate or not.

The foregoing objective of the present invention is attained by the pressure detection device composed of a container, a first conduit, and a second conduit. The container defines a liquid storage space therein for receiving a liquid and includes a first through hole, a second through hole, and an extended portion protruding outward from a bottom end of the second through hole and into the liquid storage space. The first conduit has a bottom end for interference fit with the container and communicates with the liquid storage space via the first through hole in such a way that the liquid storage space is communicable with outside via the first conduit. The second conduit has a bottom end for interference with the container and communicates with the liquid storage space via the second through hole in such a way that the liquid in the liquid storage space is forced by differential atmospheric pressure to flow into the second conduit.

In light of the above, the difference between the liquid level of the second conduit and that of the container is converted into a mercury column pressure and then compared with the pressure measured by the electronic manometer, such that it is detected as to whether the measuring result of the electronic manometer is accurate or not.

### BRIEF DESCRIPTION OF THE DRAWINGS

FIG. 1 is a perspective view of a first preferred embodiment of the present invention.

FIG. 2 is a sectional view of the first preferred embodiment of the present invention.

FIG. 3 is another sectional view of the first preferred embodiment of the present invention in operation.

FIG. 4 is a side view of the first preferred embodiment of the present invention, showing an alternative second conduit.

FIG. 5 is a sectional view of a second preferred embodiment of the present invention.

FIG. 6 is a sectional view of a third preferred embodiment of the present invention.

### DETAILED DESCRIPTION OF PREFERRED EMBODIMENTS

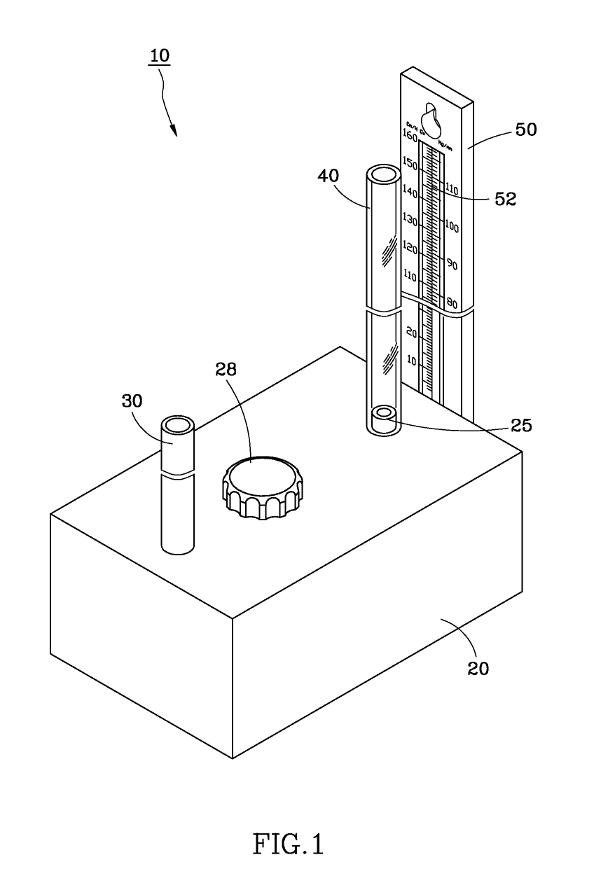

Referring to FIG. 1, a pressure detection device 10 for use in an electronic manometer (not shown) in accordance with a first preferred embodiment of the present invention is composed of a container 20, a first conduit 30, and a second conduit 40. The detailed descriptions and operations of these elements as well as their interrelations are recited in the respective paragraphs as follows.

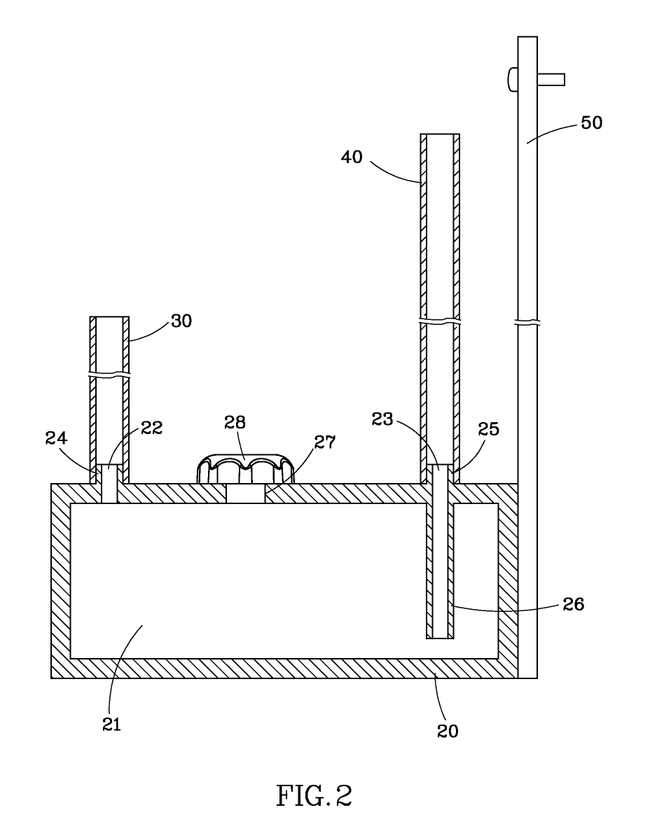

Referring to FIG. 2, the container 20 includes a liquid storage space 21 therein for containing a liquid, such as water. The container 20 includes a first through hole 22, a second through hole 23, a first joint 24 protruding outward from a top edge of the first through hole 22, a second joint protruding outward from a top edge of the second through hole 23, and an extended portion 26 protruding outward from a bottom edge of the second through hole 23 into the liquid storage space 21. A bottom end of the extended portion 26 is close to a bottom side of the container 20. The container 20 includes a liquid inlet 27 for a liquid 12 to pass through to enter the container 20. A sealing cap 28 can be mounted to the liquid inlet 27 by interference fit to seal the container 20.

The first conduit 30 includes a bottom end connected with the first joint 24 of the container 20 by interference fit for communication with the liquid storage space 21 via the first through hole 22.

The second conduit 40 also includes a bottom end connected with the second joint 25 by interference fit for communication with the liquid storage space 21 via the second through hole 23.

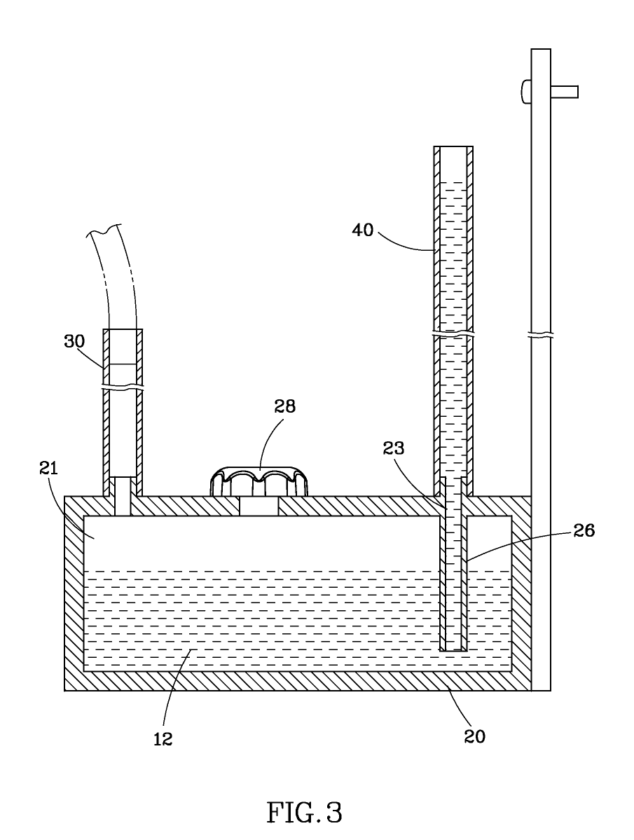

The process and features of operating the present invention are recited below as shown in FIG. 3.

First, open the sealing cap 28 and then pour water 12 into the liquid storage space 21 in 80% full and seal the sealing cap 28. Next, connect a top end of the first conduit 30 directly or indirectly to an inflatable tube of the electronic manometer to facilitate drawing the air, which pressure is identical to that of a pressure transducer (not shown), from the electronic manometer and to allow the air to enter the liquid storage space 21 through the first conduit 30. In the meantime, the water 12 in the liquid storage space 21 rises along the extended portion 26 and the second through hole 23 and flows into the second conduit, as the pressure inside the container 20 rises, and then rises along the second conduit 20 for a predetermined height. In this way, as long as the water level of the second conduit 40 is measured to get a height, then a height of the liquid inside the container is deducted from the aforesaid height to get a difference, further the difference is converted into a mercury column pressure, and finally the mercury column pressure is compared with the pressure measured by the electronic manometer, it could be detected as to whether the measuring outcome of the electronic manometer is accurate or not.

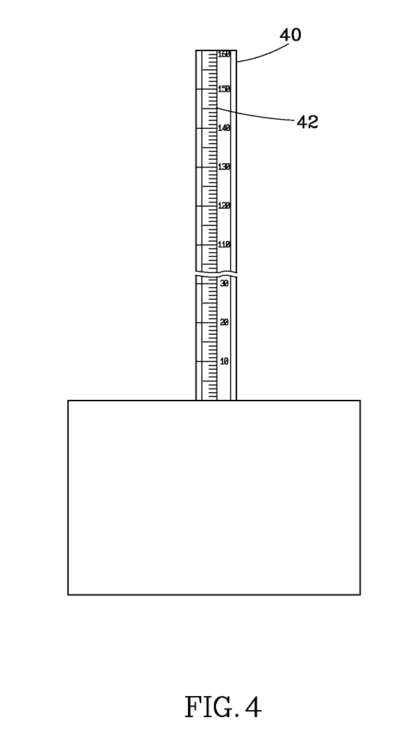

To facilitate measuring the liquid level of the second conduit 40, the pressure detection device 10 of the present invention further includes a ruler 50 having a scale 52 facing the second conduit 40, as shown in FIG. 1, to facilitate the user to directly observe the value indicated on the scale 52 that the liquid level of the second conduit 40 is aligned with. The value indicated on the scale 52 must correspond to the density of the liquid in the container 20. Alternatively, the second conduit can have a graduation 42 defined on its surface and functioning as the scale 52, as shown in FIG. 4, for the same purpose of convenient measurement.

To sum up, the pressure detection device of the present invention can effectively detect whether the measuring outcome of the electronic manometer is accurate or not to allow the hypertensive patient with the assistance of the present invention to operate the electronic manometer for monitoring and getting hold of the his or her condition at any time.

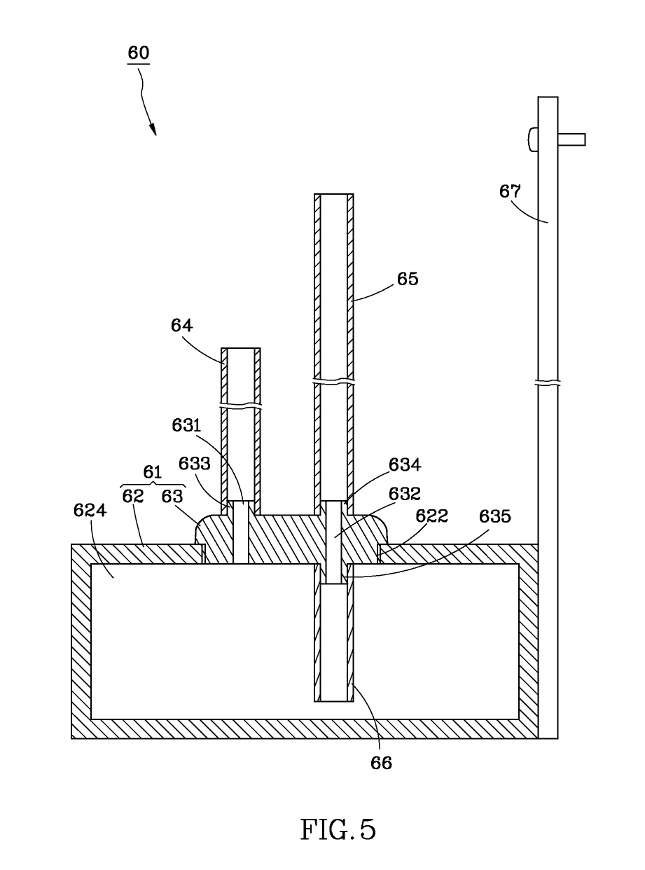

Referring to FIG. 5, a pressure detection device 60 constructed according to a second preferred embodiment of the present invention is similar to that of the first embodiment, having the following difference. The container 61 includes a main body 62 and a sealing cap 63. The main body 62 has a threaded hole 622 for the liquid to enter. The sealing cap 63 is screwed with the threaded hole 622 and has a first through hole 631 and a second through hole 632. The sealing cap 63 has a first joint 633 protruding outward from a top edge of the first through hole 631 for interference fit with the first conduit 64, a second joint 634 protruding outward from a top edge of the second through hole 632 for interference fit with the second conduit 65, and an extended portion 635 protruding from a bottom edge of the second through hole and into the liquid storage space 624 for interference with a third conduit 66. A bottom end of the third conduit is close to a bottom side of the container 61.

When the air having the same pressure as that of the pressure transducer is directly or indirectly drawn from the electronic manometer through the first through hole 631 into the liquid storage space 624, the water in the liquid storage space 624 enters the third conduit 66 due to the pressure difference, then flows into the second conduit 65 through the second through hole 632, and finally rises up to a predetermined height along the second conduit 65. Next, measure the level of the water in the second conduit 65 to get a height, deduct a height of the water in the container 61 from the aforesaid height to get a difference, convert the difference into a mercury column pressure, and finally compare the mercury column pressure with the user's blood pressure measured by the electronic manometer to detect whether the measuring result of the electronic manometer is accurate or not.

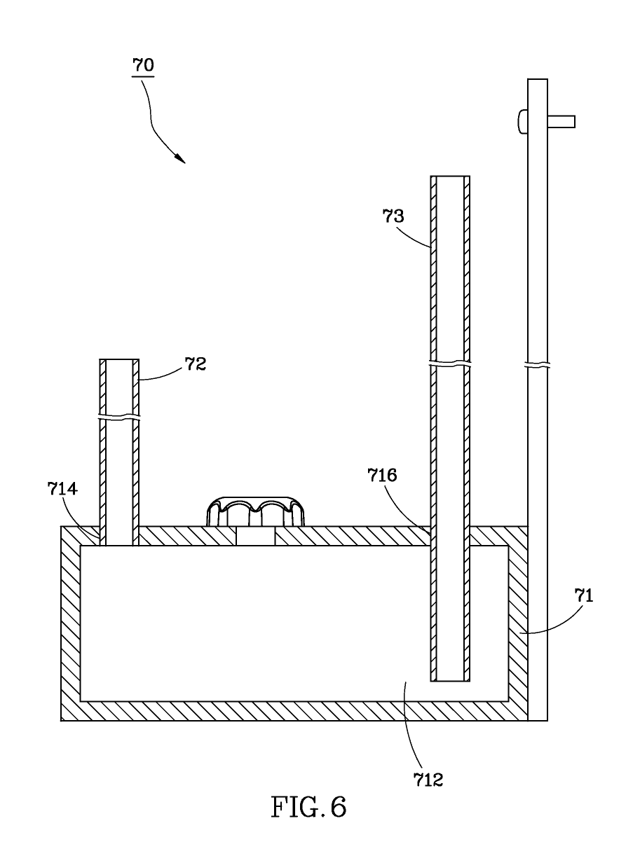

Referring to FIG. 6, a pressure detection device 70 constructed according to a third preferred embodiment of the present invention is similar to that of the first embodiment, having the difference that the first conduit 72 is inserted into the first through hole 714 of the container 71 by interference fit, and the second conduit 73 is inserted through the second through hole 716 by interference fit and extends into the liquid storage space 712 for communication with the liquid storage space 712. Because the operation and features of operating the pressure detection device 70 are identical to those of the first embodiment, no more recitation in this regard is necessary.

Although the present invention has been described with respect to specific preferred embodiments thereof, it is in no way limited to the specifics of the illustrated structures but changes and modifications may be made within the scope of the appended claims.

What is claimed is:

1. A pressure detection device for an electronic manometer, comprising:
a container defining a liquid storage space therein and having a through hole, a second through hole, and an extended portion, the extended portion protruding outward from a bottom edge of the second through hole into the liquid storage space;
a first conduit having a bottom end connected with the container by interference fit and communicating with the liquid storage space through the first through hole; and
a second conduit having a bottom end connected with the container by interference fit and communicating with the liquid storage space through the second through hole.

2. The pressure detection device as defined in claim 1, wherein the container comprises a joint protruding outward from a top edge of the first through hole for interference with the first conduit.

3. The pressure detection device as defined in claim 1, wherein the container comprises a joint protruding outward from a top edge of the second through hole for interference with the second conduit.

4. The pressure detection device as defined in claim 1 further comprising a ruler, wherein the ruler has a scale facing the second conduit.

5. The pressure detection device as defined in claim 1, wherein the second conduit comprises a graduation defined on a surface of the second conduit.

6. The pressure detection device as defined in claim 1 further comprising a sealing cap, wherein the container comprises a liquid inlet, the sealing cap being detachably mounted to the liquid inlet.

7. The pressure detection device as defined in claim 1, wherein the extended portion of the container comprises a bottom end close to a bottom side of the container.

8. The pressure detection device as defined in claim 1, wherein the container comprises a main body and a sealing cap, the main body having a threaded hole, the sealing cap being screwed with the threaded hole; the first through hole, the second through hole, and the extended portion are located on the sealing cap.

9. The pressure detection device as defined in claim 8, wherein the sealing cap comprises a joint protruding outward from a top edge of the first through hole for interference fit with the first conduit.

10. The pressure detection device as defined in claim 8, wherein the sealing cap comprises a joint protruding outward from a top edge of the second through hole for interference fit with the second conduit.

11. The pressure detection device as defined in claim 8 further comprising a third conduit, wherein the third conduit has a top end connected with the extended portion by interference fit, a bottom end of the third conduit being close to a bottom side of the container.

12. The pressure detection device as defined in claim 8 further comprising a ruler, wherein the ruler has a scale facing the second conduit.

13. The pressure detection device as defined in claim 8, wherein the second conduit comprises a graduation defined on a surface of the second conduit.

14. A pressure detection device for an electronic manometer, comprising:
a container defining a liquid storage space therein and having a through hole and a second through hole;
a first conduit having a bottom end inserted into the first through hole by interference fit and communicating with the liquid storage space through the first through hole; and
a second conduit inserted through the second through hole by interference fit and extending into the liquid storage space for communication with the liquid storage space.

15. The pressure detection device as defined in claim 14 further comprising a ruler, wherein the ruler has a scale facing the second conduit.

16. The pressure detection device as defined in claim 14, wherein the second conduit comprises a graduation defined on a surface thereof.

17. The pressure detection device as defined in claim 14 further comprising a sealing cap, wherein the container has a liquid inlet, the sealing cap being detachably mounted to the liquid inlet.
